(19) United States
(12) Patent Application Publication
(10) Pub. No.: US 2020/0159873 A1
(43) Pub. Date: May 21, 2020

(54) Methods of Identifying Models for Iterative Model Developing Techniques

(71) Applicant: Liquid Biosciences, Inc., Aliso Viejo, CA (US)

(72) Inventors: Patrick Lilley, Aliso Viejo, CA (US); Michael Colbus, Upland, CA (US); Reece Colbus, Upland, CA (US); Hunter Colbus, Upland, CA (US)

(21) Appl. No.: 15/729,450

(22) Filed: Oct. 10, 2017

(51) Int. Cl. G06F 17/50; G06N 3/12

(52) U.S. Cl. CPC G06F 17/5009; G06F 2217/16; G06N 3/126

(57) ABSTRACT

Systems and methods of reducing computation time required to implement iterative model development techniques. Methods of the inventive subject matter are directed to the generation and identification of models having desirable characteristics that can be used to seed iterative model development techniques, thereby reducing required computation time. Models are generated and then various parameters and metrics describing attributes of those models are determined. Model development is ceased depending on one or any combination of the various parameters and metrics.

### FIELD OF THE INVENTION

The field of the invention is model development and identification of useful models.

### BACKGROUND

The background description includes information that may be useful in understanding the present invention. It is not an admission that any of the information provided in this application is prior art or relevant to the presently claimed invention, or that any publication specifically or implicitly referenced is prior art.

Many iterative model development techniques, such as genetic programming techniques, are computationally intensive. Although these techniques are capable of producing high quality results, they are often so computationally demanding that they cannot feasibly be implemented. Oftentimes, iterative model development techniques like these can take weeks, months, or even years to produce desirable results, even with the fastest computers in the world working on the problems.

But past efforts to implement iterative model development techniques have failed to appreciate improvements that can dramatically reduce computation time. One reason why iterative model development techniques can be so computationally intensive is because the technique must develop all aspects of a useful model by making only very small changes to those models over time, and the models that iterative model development techniques begin with often have zero, if any, useful attributes. Thus, useful attributes must be developed over time, which can be very time consuming and computationally expensive. In some situations, some models can diverge from a useful result, never developing useful attributes at all.

Thus, past efforts at implementing iterative model development techniques have failed to appreciate how to improve the speed of model development by implementing new model selection methods.

### SUMMARY OF THE INVENTION

The present invention provides apparatus, systems, and methods in which the amount of time required for a computer to develop a model is dramatically reduced.

In one aspect of the inventive subject matter, a method of decreasing computation time required to develop useful models using an iterative model development process, where the models relate predictors and outcomes in datasets is contemplated. The method includes the following steps: (1) creating, from a dataset, at least two subsets of data; (2) generating a set of models; (3) applying each model from the set to a subset of data, to determine parameters for each model, where model parameters include accuracy, sensitivity, and specificity of each model; (4) applying each model to a second subset to determine second parameters for each model, where the second parameters include a second accuracy, a second sensitivity, and a second specificity; (5) determining a consistency parameter for a model, where the consistency parameter is a function of at least one of the parameters developed using the first subset of data and at least one of the parameters developed using the second subset of data; and (6) determining, based on the consistency parameter, whether to cease model development.

The consistency parameter can include several attributes, including: (1) an accuracy consistency of a model, where the accuracy consistency comprises a function of accuracies of the model across different subsets of the data; (2) a sensitivity consistency of a model, where the sensitivity consistency comprises a function of sensitivities of the model across different subsets of the data; and (3) a specificity consistency of the model, where the specificity consistency comprises a function of specificities of the model across different subsets of the data.

In some embodiments, the method can further include the steps of: (1) determining a consistency metric for each model, wherein the consistency metric is a function of accuracy consistency, sensitivity consistency, and specificity consistency of each model; (2) determining a sensitivity metric for each model, wherein the sensitivity metric is a function of an average sensitivity and the sensitivity consistency of each model; and (3) determining a specificity metric for each model, wherein the specificity metric is a function of an average specificity and the specificity consistency of each model.

The step of determining whether to cease model development can also be based on any combination of the consistency metric, the sensitivity metric, and the specificity metric of each model. It is also contemplated that methods of the inventive subject matter can contemplate balance between different metrics. For example, methods can include the additional steps of determining a balance of a model, wherein the balance is a function of the sensitivity metric and the specificity metric, and determining a balance metric of a model, wherein the balance metric is a function of the sensitivity metric, the specificity metric, and the balance. Accordingly, the step of determining whether to cease model development can also be based on any combination of the balance or the balance metric of one or more models.

In another aspect of the inventive subject matter, a method of decreasing computation time required to develop useful models using an iterative model development process, where the models relate predictors and outcomes in datasets, is contemplated. The method includes the steps of: (1) creating, from a dataset, at least three subsets; (2) generating a set of models; (3) applying each model of the set of models to each of the three subsets, to determine subset parameters for each subset, where the subset parameters include accuracy of each model, sensitivity of each model, and specificity of each model; (4) determining a consistency parameter of a model, where the consistency parameter is a function of one or more subset parameters; and (5) determining, based on the consistency parameter, whether to cease model development.

In some embodiments, the consistency parameter can also include: (1) an accuracy consistency of a model, where the accuracy consistency comprises a function of model accuracies across subsets of the data; (2) a sensitivity consistency of a model, wherein the sensitivity consistency comprises a function of model sensitivities across subsets of the data; and (3) a specificity consistency of the model, where the specificity consistency comprises a function of mode specificities across subsets of the data.

It is also contemplated that the method can include the following steps: (1) determining a consistency metric for a model, where the consistency metric is a function of accuracy consistency, sensitivity consistency, and specificity consistency of the model; (2) determining a sensitivity metric for the model, where the sensitivity metric is a function of an average sensitivity and the sensitivity consistency of the model; and (3) determining a specificity metric for the model, where the specificity metric is a function of an average specificity and the specificity consistency of the model.

As with the aspect described above, the step of determining whether to cease model development can also be based on any combination of the consistency metric, the sensitivity metric, and the specificity metric of the model. In addition, the method can include the additional steps of: (1) determining a balance, where the balance is a function of any combination of the sensitivity metric and the specificity metric, and (2) determining a balance metric, where the balance metric is a function of any combination of the sensitivity metric, the specificity metric, and the balance.

It is contemplated that the step of determining whether to cease model development can also be based on the balance metric, and in some embodiments, the method can include the added step of determining a bias for each model. Bias is a function of any combination of the average sensitivity and the average specificity for each model. Finally, it is contemplated that the step of determining whether to cease model development can also be based on the bias.

In another aspect of the inventive subject matter, a method of decreasing computation time required to develop useful models using an iterative model development process, where the models relate predictors and outcomes in datasets, is contemplated. The method includes the steps of: (1) creating, from a dataset, at least a training subset and a validation subset; (2) generating a set of models; (3) applying each model of the set of models to the training subset, to determine training parameters, where training parameters include a training accuracy of each model, a training sensitivity of each model, and a training specificity of each model; (4) applying each model of the set of models to the validation subset to determine validation parameters, where the validation parameters include a validation accuracy of each model, a validation sensitivity of each model, and a validation specificity of each model; (4) determining a first consistency parameter of a first model in the set of models, wherein the first consistency parameter is a function of any combination of the training parameters and the validation parameters for the first model; (5) determining a second consistency parameter of a second model in the set of models, wherein the second consistency parameter is a function of at least one of the training parameters and at least one of the validation parameters for the second model; and (6) determining, based on the first and second consistency parameters, whether to cease model development.

In some embodiments, the step of determining whether to cease model development also includes a comparison between the first and second consistency parameters.

One should appreciate that the disclosed subject matter provides many advantageous technical effects including a dramatic and measurable decrease in computation time required to develop a model through iterative model development techniques such as genetic programming. This improvement helps to make advanced model development techniques computationally feasible when they otherwise would be too time consuming and computationally intensive to be possible in a reasonable amount of time.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a dataset broken into n subsets.

FIG. 2 shows a model generator module.

FIG. 3 shows a model parameter generation module as it is applied to a first subset of data.

FIG. 4 shows a model parameter generation module as it is applied to a second subset of data.

FIG. 5 shows a consistency parameter generation module.

FIG. 6 illustrates a model consistency parameter.

FIG. 7 shows a flow diagram illustrating a method of the inventive subject matter.

FIG. 8 shows an accuracy consistency module.

FIG. 9 shows a sensitivity consistency module.

FIG. 10 shows a specificity consistency module.

FIG. 11 shows a consistency metric module.

FIG. 12 shows a sensitivity metric module.

FIG. 13 shows a specificity metric module.

FIG. 14 shows a balance module.

FIG. 15 shows a balance metric module.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Embodiments of the inventive subject matter described in this application can be implemented to facilitate model development, especially when used in association with iterative model development techniques. One example of an iterative model development technique is an implementation of genetic programming to develop models (e.g., algorithms) that relate predictors and outcomes in datasets. Predictors, as used in this application, can refer to any type of item or information that directly or indirectly can be used to determine an outcome.

With datasets that are sufficiently large, and especially datasets that are highly dimensional, computation time required to iteratively develop a model capable of receiving predictors as inputs and outputting useful outcomes is frequently too great to make these techniques feasible. Embodiments of the inventive subject matter make many iterative model development techniques, including genetic programming, computationally feasible by bringing computation time from, in some cases, thousands of years to down to several minutes, hours, or days.

The term “model” as used in this application refers a mathematically descriptive entity, such as an algorithm. Models are used to predict outcomes based on a set of predictors. Predicted outcomes can be compared to a measured or recorded outcome, and one goal of the inventive subject matter is to provide for methods that facilitate faster convergence on useful models in the course of an iterative model development process.

Embodiments of the inventive subject matter are directed to early identification of models that are useful, based on one or more of several different parameters that describe aspects of each model. In this context, “useful” can mean that one or more of the several different parameters that describe aspects of each model indicate the model has desirable properties, either in an absolute sense or relative to other models (e.g., a model is accurate, a model is well-balanced, a model has high sensitivity, a model has high specificity, or any combination of the different parameters described in this application).

To implement methods of the inventive subject matter, a sufficiently large dataset must be divided into multiple groups (e.g., a dataset with at least four entries, so that it can be divided into two groups of two, though very large datasets are preferable). Additionally, datasets must contain predictors and outcomes, where each set of predictors (e.g., one or more predictors) relates to a set of outcomes (e.g., one or more outcomes). There is no theoretical limit to the size or dimensionality of a dataset that methods of the inventive subject matter can be applied to.

It should be noted that many of the steps described in this application can be completed irrespective of the order they appear in this application. Some steps can be completed simultaneously, and some can be completed in sequence.

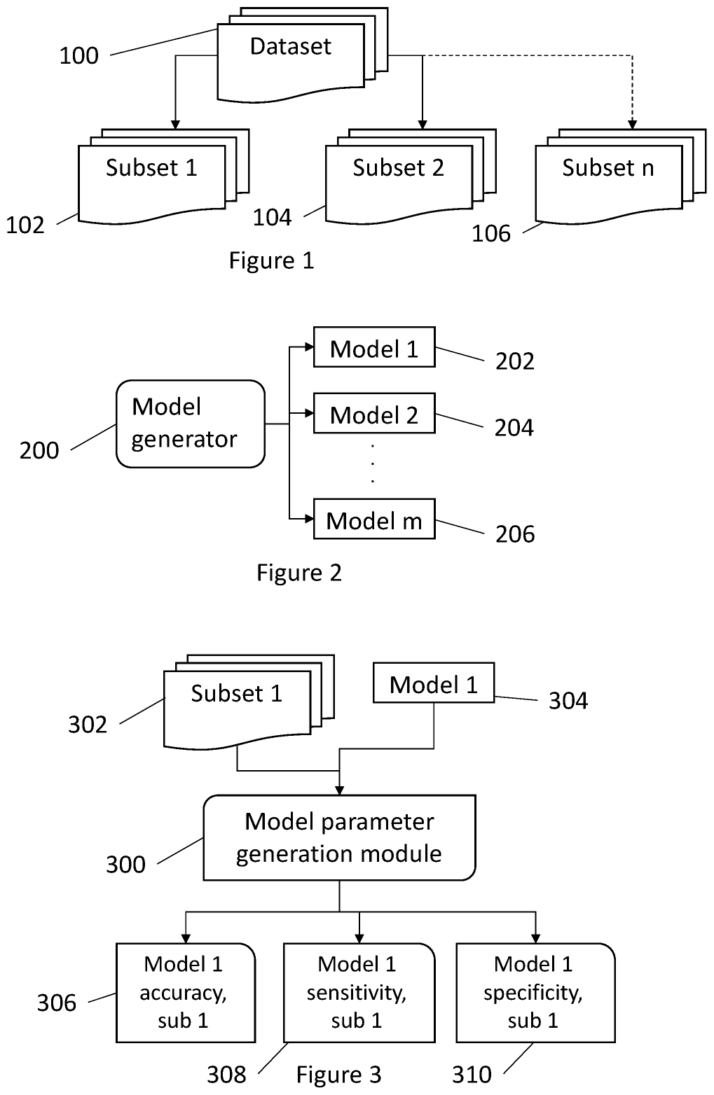

A first step in methods of the inventive subject matter is to divide a dataset 100 into multiple subsets 102, 104, & 106, as shown in FIG. 1. The number of subsets is limited only by the size of the dataset. In some embodiments, each subset is mutually exclusive, though it is contemplated that one or more of the subsets can contain overlapping sets of predictors and outcomes. FIG. 1 shows a dataset 100 divided into subsets 1, 2, and n (102, 104, & 106), where n represents a theoretical number to show that there is no limit to the quantity of subsets that can be created from the dataset 100.

Another step in methods of the inventive subject matter is model generation. Model generation is completed by a model generator module 200, as shown in FIG. 2. The number of models can be generated is theoretically unlimited, which is illustrated in FIG. 2 by showing that the model generator module 200 has generated models 1 and 2 through m (202, 204, & 206), where m represents a theoretical number to show that there is no limit to the quantity of models that can be created by the model generator 200. At least one model is required.

Models generated according to the inventive subject matter are, in some embodiments, random. One goal in creating random models is to attempt to span many different possible models having many different attributes and combinations of attributes in an effort to identify those models that have a greater potential to be used in, e.g., an iterative model development process. For example, if among 1000 random models, 10 of those models have some measurable accuracy (e.g., the accuracy satisfies some threshold level) in predicting an outcome given a set of predictors, then those 10 models can be used to seed a genetic programming model development technique where high accuracy is desired, thereby dramatically reducing the amount of time required to identify and evolve accurate models using the genetic programming technique on purely random models. It can therefore be advantageous to generate many models to increase the possibility that a model has attributes that are useful in predicting an outcome using a set of predictors.

Once a dataset is divided into subsets, each model is applied to each subset. By applying a model to a subset, parameters associated with that model can be developed. FIG. 3 shows a model parameter generation module 300. The model parameter generation module 300 receives a first subset of a dataset 302 and a first model 304. It is contemplated that additional inputs can be received, but a subset and a model are required at a minimum. It then outputs at least three different model parameters: model accuracy 306, model sensitivity 308, and model specificity 310. Inputs to the model parameter generation module are used according to a function that generates an output (or set of outputs) representative of the inputs, where the output of the function has only one output for a unique input (or set of inputs).

To generate the different model parameters 306, 308, & 310, the model parameter generation module 300 applies the predictors from the subset 302 to the first model 304 (and, more generally, any subset and model can be input into the model parameter generation module). One goal of each model is to take a set of predictors as inputs and to output a set of outcomes that matches the set of outcomes that is associated with that set of predictors. As mentioned above, it is contemplated that each set of predictors and outcomes can include one or more predictors and outcomes. Thus, for example, a “set of outcomes” in this application can refer to a single outcome.

Model accuracy can be described as a model's ability to accurately predict an outcome based on the predictors it uses as input to generate that prediction. It is contemplated that a model's accuracy can be determined based on that model's ability to accurately predict outcomes when applied to two or more sets of data. For example, if a model accurately predicts an outcome 7 times out of 10, then that model can have an accuracy of 70%. In embodiments where the outcome is non-binary (e.g., there is more than one outcome), it is contemplated that an accuracy can be determined for each category. It is thus contemplated that a model's accuracy can take into account its ability to accurately predict several outcomes (e.g. by averaging the model's accuracy for different outcomes). A model's accuracy can be a function its accuracy when applied to all or some of a subset of a dataset.

In one example, a model accuracy can be an average of that model's accuracy across all of the data in the subset that it is applied to. In one embodiment, a model is applied to all of the sets of predictors contained in a subset, and for each set of predictors, if a model accurately predicts an outcome (or set of outcomes), then it is counted as successful. If the model does not accurately predict an outcome, then it is counted as unsuccessful. Thus, once the model is applied to all of the data in the subset, a percent of successful predictions can be generated, and that percent can be the model's accuracy.

Although arithmetic averaging is contemplated, is it also contemplated that any other statistical measurement or quantification method can be implemented to develop a model's accuracy parameter for each model applied to each subset. The same is true for all parameters and metrics contemplated in this application.

Model sensitivity measures the proportion of positives (e.g., successful predictions) that are correctly identified as such (e.g., the percentage of sick people who are correctly identified as having the illness-causing condition). Generally speaking, a highly sensitive model will produce false positives, but will produce very few false negatives.

Model specificity, on the other hand, measures the proportion of negatives that are correctly identified as such (e.g., the percentage of healthy people who are correctly identified as not having the condition). In a model with high specificity, for example, no healthy individual would be incorrectly identified as sick.

Thus, a model with both high sensitivity and high specificity identifies very few false positives and very few false negatives, meaning it is adept at correctly predicting an outcome (or outcomes) based on a set of predictors. It is frequently the goal of many models to be both highly specific and highly sensitive, but in some situations, it can be important to develop a model that is first more sensitive than specific. For example, if a medical test is extremely expensive, it can be important to quickly and inexpensively narrow the pool of potential patients. By first running a test that is more sensitive than specific, patients that (within some tolerance level) are established as not needing the test are eliminated as potentials. Then, the remaining patients can be subjected to the expensive test.

Thus, by determining accuracy, specificity, and sensitivity of a model, any one or combination of those parameters can be used to select a model to use in an iterative model developing process. By seeding an iterative model development process with one or more models having desirable characteristics (as determined by their parameters), models exhibiting those parameters can be developed more quickly using iterative model development techniques.

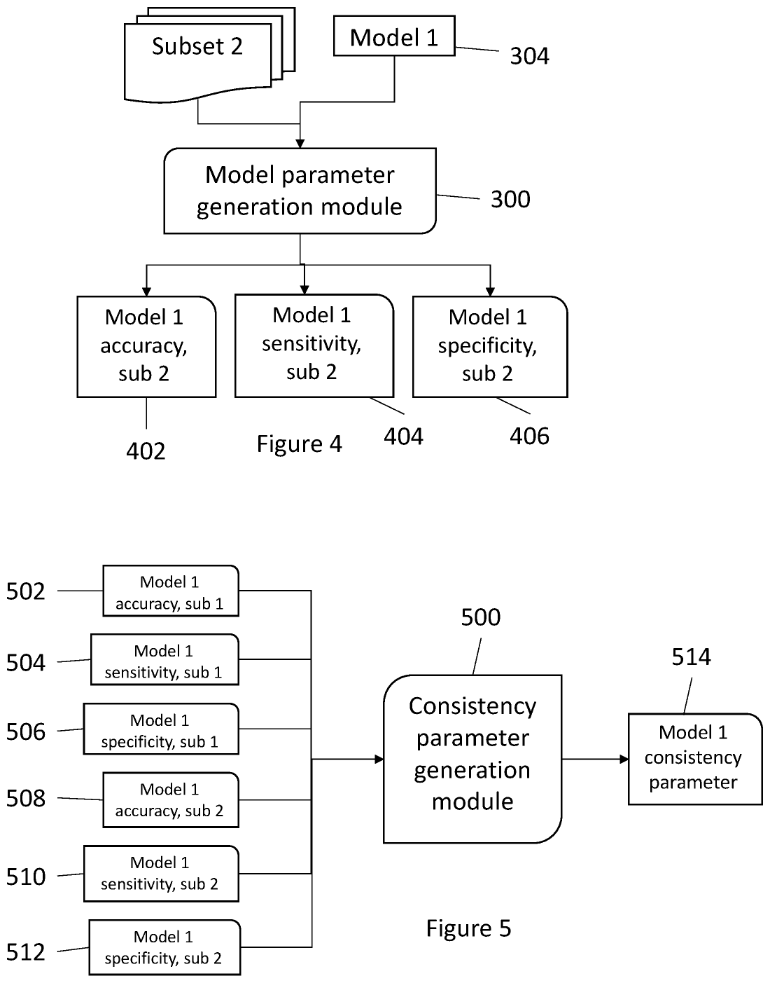

FIG. 4 shows the model parameter generation module 300 that receives the same model 304 as in FIG. 3 as an input alongside a second subset 400 of the dataset. Thus, the model parameter generation module 300 determines at least three model parameters for the model as applied to the second subset 400: model accuracy 402, model sensitivity 404, and model specificity 406. Thus, each model parameter generated by the model parameter generation module 300 is associated with a particular model as applied to a particular subset.

With model parameters developed for a model as applied to multiple subsets of data, a consistency parameter can be generated for the model. FIG. 5 shows a consistency parameter generation module 500. The consistency parameter generation module 500 receives, as input, model accuracy, specificity, and sensitivity as determined by the model parameter generation module using several different subsets with the same model, and it outputs a consistency parameter specific to that model. Thus, a first subset model accuracy 502, sensitivity 504, and specificity 506, along with a second subset model accuracy 508, sensitivity 510, and specificity 512 are shown in FIG. 5. It is contemplated that more of the same types of parameters can be received by the consistency parameter generation module 500 for any number of subsets as applied to a model. The output from the consistency parameter generation module 500, as shown in FIG. 5, is a consistency parameter 514 that is specific to a particular model. Inputs to the consistency parameter generation module are used according to a function that generates an output (or set of outputs) representative of the inputs, where the output of the function has only one output for a unique input (or set of inputs).

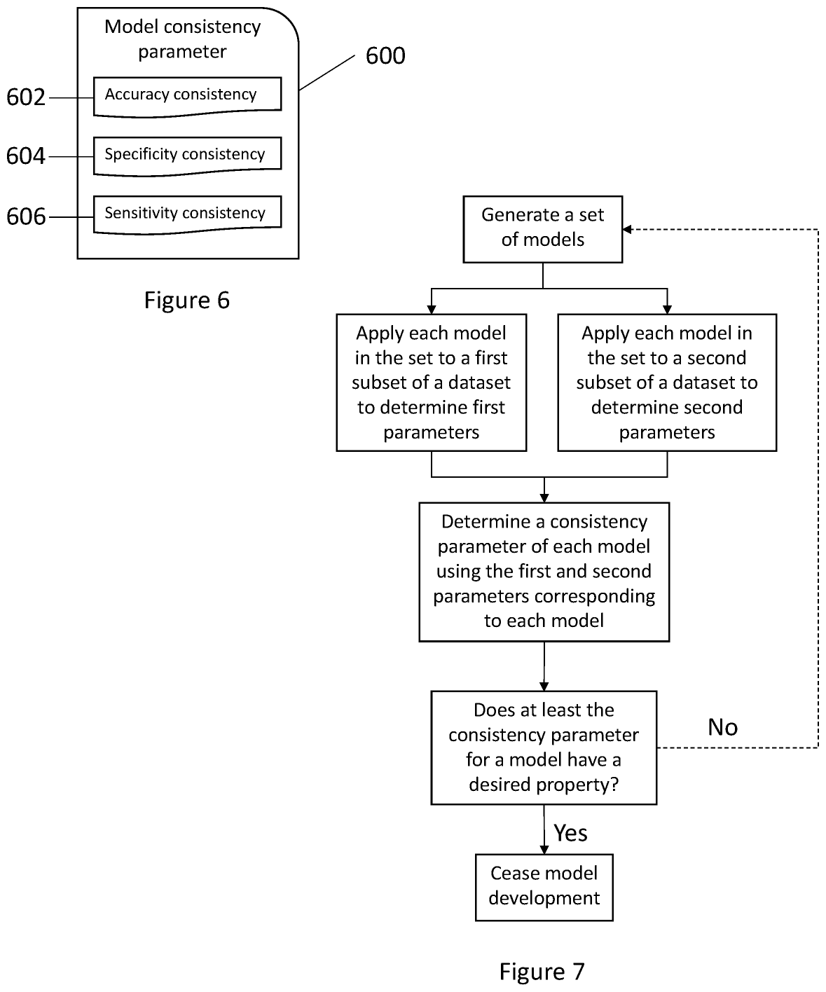

FIG. 6 shows an example consistency parameter 600 comprising accuracy consistency 602, specificity consistency 604, and sensitivity consistency 606. It is contemplated that the consistency parameter 600 can include one, some, or all of accuracy consistency, specificity consistency, and sensitivity consistency (e.g., either including one, some, or all of the parameters directly, or including a function of one, some or all of the parameters).

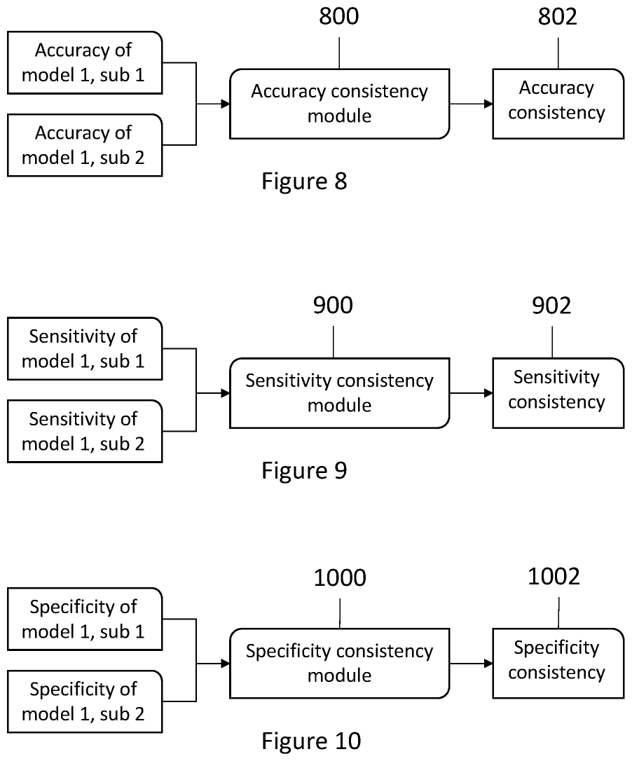

Accuracy consistency 802, which is produced by an accuracy consistency module 800 using a model's accuracies as measured across different subsets of a dataset as shown in FIG. 8, for example, describes a model's ability to consistently produce accurate predictions of outcomes using sets of predictors across different subsets (e.g., two or more subsets). Inputs to the accuracy consistency module 800 are used according to a function that generates an output (or set of outputs) representative of the inputs, where the output of the function has only one output for a unique input (or set of inputs).

Sensitivity consistency 902, which is produced by a sensitivity consistency module 900 using a model's sensitivities as measured across different subsets of a dataset as shown in FIG. 9, for example, describes a model's consistency of sensitivity across different subsets (e.g., two or more subsets). Inputs to the sensitivity consistency module 900 are used according to a function that generates an output (or set of outputs) representative of the inputs, where the output of the function has only one output for a unique input (or set of inputs).

Specificity consistency 1002, which is produced by a specificity consistency module 1000 using a model's specificities as measured across different subsets of a dataset as shown in FIG. 10, for example, describes a model's consistency of sensitivity across different subsets (e.g., two or more subsets). Inputs to the specificity consistency module 1000 are used according to a function that generates an output (or set of outputs) representative of the inputs, where the output of the function has only one output for a unique input (or set of inputs).

Developing a consistency parameter for each model helps to facilitate identification of a model that can trigger a determination that model development should cease. As shown in the flow chart of FIG. 7, it is contemplated that after model generation, and after applying a model to at least two subsets of data and then developing parameters for that model (including a consistency parameter), the question of whether to continue model development (e.g., should a new set of models be developed and the process restarted) can depend on at least the consistency parameter of that model. In other embodiments, whether to cease model development can additionally or alternatively be based on any of the parameters or metrics associated with that model. For example, the decision to cease model development can depend on a model's accuracy parameter along with its consistency parameter where it is desirable for a model to be both accurate and consistent. The same is true for any combination of parameters, metrics, and consistencies.

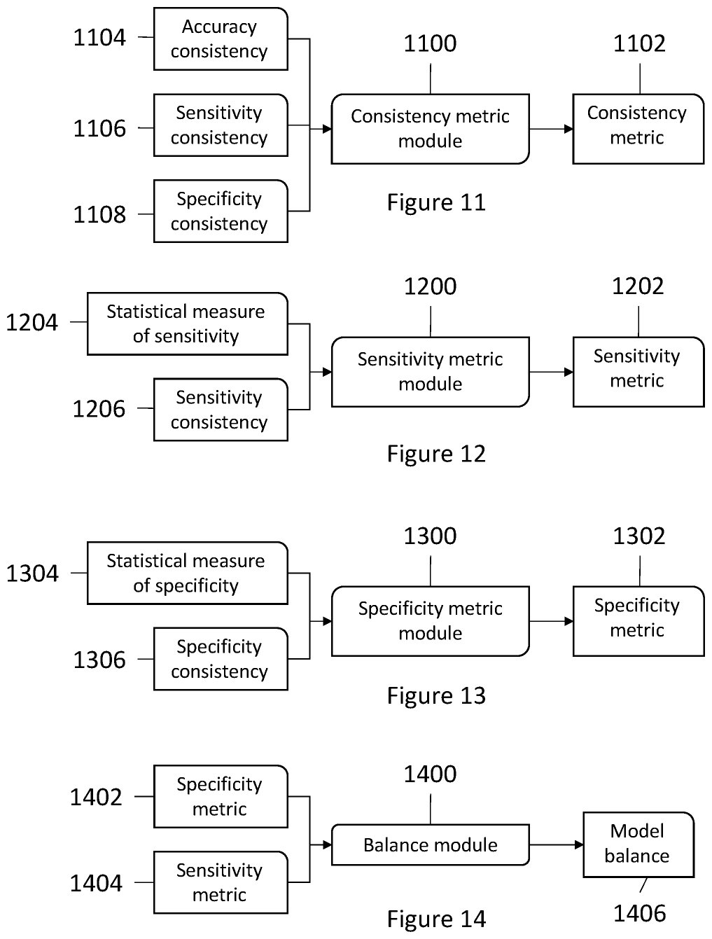

A consistency metric 1102 is also contemplated, and is created using a consistency metric module 1100 as shown in FIG. 11. A consistency metric, in some embodiments, takes into account a model's accuracy consistency 1104, specificity consistency 1106, and sensitivity consistency 1108. Unlike an individual consistency parameter (e.g., accuracy consistency, sensitivity consistency, and specificity consistency) the consistency metric can take all of these parameters into account for a given model and express that in a single metric. Inputs to the consistency metric module 1100 are used according to a function that generates an output (or set of outputs) representative of the inputs, where the output of the function has only one output for a unique input (or set of inputs). In one embodiment, the consistency metric module 1100 outputs a geometric mean of all of the consistency parameters (e.g., accuracy consistency, specificity consistency, and sensitivity consistency) that it receives as input.

The consistency metric module 1100 can additionally normalize the consistency metric of a model relative to all other consistency metrics of the other models in the set of models. For example, if there are 10 models, each having a consistency metric, then the consistency metric for a particular model could be that model's consistency divided by the average (or any other statistical measurement such as a geometric mean or a median) of the consistencies of all of the 10 models in that set.

This same approach of normalizing can be implemented with respect to any of the different parameters or metrics described in this application to produce a normalized version of that parameter or metric. For any parameter or metric, a normalization can be developed by taking into account a set of the same type of parameter or metric where the members of the set each correspond to different models in the set of models. A set of the same type of parameter can be statistically manipulated to facilitate normalization as described above.

A sensitivity metric 1202 is also contemplated, and a sensitivity metric module 1200 is shown in FIG. 12. The sensitivity metric can take into account a statistical measurement of a model's sensitivity 1204 (e.g., a geometric or arithmetic average of a model's sensitivities as determined across multiple subsets of data, or a geometric or arithmetic average of several sensitivities corresponding to several different models) and sensitivity consistency 1206 (e.g., a particular model's sensitivity consistency).

Inputs to the sensitivity metric module 1200 are used according to a function that generates an output (or set of outputs) representative of the inputs, where the output of the function has only one output for a unique input (or set of inputs). In one embodiment, the sensitivity metric module 1200 outputs the product of a model's average sensitivity and the model's sensitivity consistency.

A specificity metric 1302 is also contemplated, and a specificity metric module 1300 is shown in FIG. 13. The specificity metric 1302 can take into account a statistical measurement of a model's specificity 1304 (e.g., a geometric or arithmetic average of a model's specificities as determined across multiple subsets of data, or a geometric or arithmetic average of several specificities corresponding to several different models) and specificity consistency 1306 (e.g., a particular model's specificity consistency).

Inputs to the specificity metric module 1300 are used according to a function that generates an output (or set of outputs) representative of the inputs, where the output of the function has only one output for a unique input (or set of inputs). In one embodiment, the specificity metric module outputs the product of a model's average specificity and the model's specificity consistency.

In some embodiments, it can be useful to determine how a model is balanced. In this context, balance refers to how a model is weighted toward one parameter or another. For example, a model can be weighted more heavily toward having a higher specificity than sensitivity. A balance module 1400 is shown in FIG. 14. The balance module 1400 receives at least one specificity metric 1402 and at least one sensitivity metric 1404 as an input, and it outputs a model balance 1406.

Inputs to the balance module 1400 are used according to a function that generates an output (or set of outputs) representative of the inputs, where the output of the function has only one output for a unique input (or set of inputs). In one embodiment, the balance metric module outputs one minus the absolute value of a different between a model's sensitivity and specificity metrics divided by the average of those two metrics (i.e., 1−abs(model sensitivity−model specificity)/avg(model sensitivity, model specificity)).

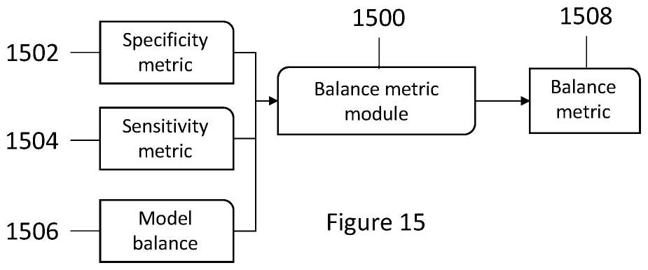

A balance metric 1508 is determined by a balance metric module 1500 as shown in FIG. 15. The balance metric module 1500 receives as input at least: a model balance 1506, a model specificity metric 1502, and a model sensitivity metric 1504. The balance metric module 1500 then determines, for example, a balance metric 1506 that takes into account a specificity metric, a sensitivity metric, and a model balance.

Inputs to the balance metric module 1500 are used according to a function that generates an output (or set of outputs) representative of the inputs, where the output of the function has only one output for a unique input (or set of inputs). In one embodiment, the balance metric module 1500 outputs a product of a specificity metric, a sensitivity metric, and a model balance.

In all of the modules described in this application, the inputs are contemplated as being one or more of the described input, and in some cases, the inputs can include other parameters or metrics not explicitly described. For example, in FIGS. 8-10, it is contemplated that in embodiments with more than one subset of data, the number of inputs per model grows accordingly (e.g., in FIG. 8, the accuracy of model 1 as applied to subsets 3-n could also be included).

It is also contemplated that additional inputs may be received by any of the modules, as the modules are not intended to be capable of receiving only the information described as inputs in the figures. Instead, the figures are meant to show a minimum of inputs for each module.

With all of the various parameters and metrics determined, those different parameters and metrics can be used in alone or in any combination to determine whether to cease model development. For example, in some embodiments, it may be advantageous to look for models with high accuracy, and cease model development when a certain degree of accuracy is determined. In other embodiments, it can be advantageous to develop a model that has high specificity and low sensitivity. Thus, whether to cease model development can depend on model sensitivity and model specificity. It is thus contemplated that determining whether to cease model development can depend on whether the various metrics and/or parameters, either alone or in combination, meet certain thresholds (e.g., if a model is sufficiently accurate, stop; if a model is sufficiently sensitive, stop).

Ultimately, determining whether to cease model development based on one, or some combination, of the parameters and metrics discussed in this application can dramatically reduce computation time required for iterative model development processes to develop useful models. For example, in genetic programming techniques, evolving models can take a very long time if all of the models begin as completely random models. It may be the case that none of the randomly seeded models include features or model components that are useful in generating useful outcome predictions, thus requiring extra time in the evolutionary model development process to arrive at useful models.

Implementations of the inventive subject matter are directed to generating and identifying models that have useful qualities or components so that those models can, in effect, seed iterative model development processes such as genetic programming techniques. When an iterative model development technique starts off with models that already include desirable qualities or components, the amount of time needed to converge on a desired model is greatly reduced, making these different techniques computationally feasible when they might not otherwise be.

In instances where, after checking whether model development should cease based on one or more of the parameters and metrics described in this application, it is determined that model development should continue, then another set of models can be generated and the process can begin anew, as demonstrated in FIG. 7, which should be interpreted as describing a general process of determining whether to cease model development based on one or any number of parameters or metrics.

Thus, specific compositions and methods of identifying useful models for iterative model development techniques have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. A method of decreasing computation time required to develop useful models using an iterative model development process using an at least one computing device, where the at least one computing device generates a set of models and the models relate predictors and outcomes in datasets, the method comprising the steps of:
the at least one computing device creating, from a dataset, at least a first subset and a second subset;
the at least one computing device applying each model of the set of models to the first subset, to determine first parameters comprising a first accuracy of each model, a first sensitivity of each model, and a first specificity of each model;
the at least one computing device applying each model of the set of models to the second subset to determine second parameters comprising a second accuracy of each model, a second sensitivity of each model, and a second specificity of each model;
the at least one computing device determining a consistency parameter of a model in the set of models, wherein the consistency parameter is a function of at least one of the first parameters and at least one of the second parameters for the model; and
the at least one computing device determining, based on the consistency parameter, whether to cease model development.

2. The method of claim 1, wherein the consistency parameter further comprises at least one of:
an accuracy consistency of the model in the set of models, wherein the accuracy consistency comprises a function of the first accuracy and the second accuracy for the model;
a sensitivity consistency of the model in the set of models, wherein the sensitivity consistency comprises a function of the first sensitivity and the second sensitivity for the model; and
a specificity consistency of the model in the set of models, wherein the specificity consistency comprises a function of the first specificity and the second specificity for the model.

3. The method of claim 2, further comprising the steps of:
the at least one computing device determining a consistency metric for the model, wherein the consistency metric is a function of accuracy consistency, sensitivity consistency, and specificity consistency of the model;
the at least one computing device determining a sensitivity metric for the model, wherein the sensitivity metric is a function of an average sensitivity and the sensitivity consistency of the model; and
the at least one computing device determining a specificity metric for the model, wherein the specificity metric is a function of an average specificity and the specificity consistency of the model.

4. The method of claim 2, wherein the step of determining whether to cease model development is also based on at least one of the consistency metric, the sensitivity metric, and the specificity metric of the model.

5. The method of claim 2, further comprising the steps of:
the at least one computing device determining a balance, wherein the balance is a function of the sensitivity metric and the specificity metric; and
the at least one computing device determining a balance metric, wherein the balance metric is a function of the sensitivity metric, the specificity metric, and the balance.

6. The method of claim 4, wherein the step of determining whether to cease model development is also based on the balance metric.

7. A method of decreasing computation time required to develop useful models using an iterative model development process using an at least one computing device, where the at least one computing device generates a set of models and the models relate predictors and outcomes in datasets, the method comprising the steps of:
the at least one computing device creating, from a dataset, at least a first subset, a second subset, and a third subset;
the at least one computing device applying each model of the set of models to the first subset, to determine first subset parameters comprising a first accuracy of each model, a first sensitivity of each model, and a first specificity of each model;
the at least one computing device applying each model of the set of models to the second subset to determine second subset parameters comprising a second accuracy of each model, a second sensitivity of each model, and a second specificity of each model;
the at least one computing device applying each model of the set of models to the third subset to determine third subset parameters comprising a third accuracy of each model, a third sensitivity of each model, and a third specificity of each model;
the at least one computing device determining a consistency parameter of a model in the set of models, wherein the consistency parameter is a function of at least one of the first subset parameters, the second subset parameters, and the third subset parameters for the model; and
the at least one computing device determining, based on the consistency parameter, whether to cease model development.

8. The method of claim 7, wherein the consistency parameter further comprises at least one of:
an accuracy consistency of the model in the set of models, wherein the accuracy consistency comprises a function of the first accuracy, the second accuracy, and the third accuracy for the model;
a sensitivity consistency of the model in the set of models, wherein the sensitivity consistency comprises a function of the first sensitivity, the second sensitivity, and the third sensitivity for the model; and
a specificity consistency of the model in the set of models, wherein the specificity consistency comprises a function of the first specificity, the second specificity, and the third specificity for the model.

9. The method of claim 8, further comprising the steps of:
the at least one computing device determining a consistency metric for the model, wherein the consistency metric is a function of accuracy consistency, sensitivity consistency, and specificity consistency of the model;
the at least one computing device determining a sensitivity metric for the model, wherein the sensitivity metric is a function of an average sensitivity and the sensitivity consistency of the model; and
the at least one computing device determining a specificity metric for the model, wherein the specificity metric is a function of an average specificity and the specificity consistency of the model.

10. The method of claim 9, wherein the step of determining whether to cease model development is also based on at least one of the consistency metric, the sensitivity metric, and the specificity metric of the model.

11. The method of claim 9, further comprising the steps of:
the at least one computing device determining a balance, wherein the balance is a function of the sensitivity metric and the specificity metric; and
the at least one computing device determining a balance metric, wherein the balance metric is a function of the sensitivity metric, the specificity metric, and the balance.

12. The method of claim 11, wherein the step of determining whether to cease model development is also based on the balance metric.

13. The method of claim 11, further comprising the step of the at least one computing device determining a bias for each model, wherein the bias is a function of the average sensitivity and the average specificity for each model of the set of models.

14. The method of claim 13, wherein the step of determining whether to cease model development is also based on the bias.

15. A method of decreasing computation time required to develop useful models using an iterative model development process using an at least one computing device, where the at least one computing device generates a set of models and the models relate predictors and outcomes in datasets, the method comprising the steps of:
the at least one computing device creating, from a dataset, at least a training subset and a validation subset;
the at least one computing device applying each model of the set of models to the training subset, to determine training parameters comprising a training accuracy of each model, a training sensitivity of each model, and a training specificity of each model;
the at least one computing device applying each model of the set of models to the validation subset to determine validation parameters comprising a validation accuracy of each model, a validation sensitivity of each model, and a validation specificity of each model;
the at least one computing device determining a first consistency parameter of a first model in the set of models, wherein the first consistency parameter is a function of at least one of the training parameters and at least one of the validation parameters for the first model;
the at least one computing device determining a second consistency parameter of a second model in the set of models, wherein the second consistency parameter is a function of at least one of the training parameters and at least one of the validation parameters for the second model; and
the at least one computing device determining, based on the first and second consistency parameters, whether to cease model development.

16. The method of claim 15, wherein the step of determining whether to cease model development further comprises a comparison of the first and second consistency parameters.
